(19) United States
(12) Patent Application Publication
(10) Pub. No.: US 2006/0039305 A1
(43) Pub. Date: Feb. 23, 2006

(54) Method and system for EAP encapsulation exchange for a setup configuration protocol in a WLAN

(76) Inventors: Manoj Thawani, Sunnyvale, CA (US); David Milne, Sunnyvale, CA (US); Henry Ptasinski, San Francisco, CA (US); Raymond Hayes, Los Gatos, CA (US)

Correspondence Address: MCANDREWS HELD & MALLOY, LTD, 500 WEST MADISON STREET, SUITE 3400, CHICAGO, IL, 60661, US

(21) Appl. No.: 11/207,661

(22) Filed: Aug. 18, 2005

Related U.S. Application Data
(60) Provisional application No. 60/602,396, filed on Aug. 18, 2004.
(60) Provisional application No. 60/671,120, filed on Apr. 14, 2005.

(51) Int. Cl. H04J 3/22; H04B 7/00; H04J 3/16

(52) U.S. Cl. 370/310; 370/466

(57) ABSTRACT

Certain aspects of a method for enabling exchange of information in a secure communication network may comprise encapsulating authentication enablement information comprising data for configuring at least one 802.11 client station. One or more 802.11 client stations may be configured without disrupting access to any other 802.11 client station that is already communicatively coupled to the network. The encapsulated authentication enablement information may be authenticated using an extensible authentication protocol (EAP).

### CROSS-REFERENCE TO RELATED APPLICATIONS/INCORPORATION BY REFERENCE

This application makes reference to: U.S. Provisional Application Ser. No. 60/602,396 filed Aug. 18, 2004; U.S. Provisional Application Ser. No. 60/671,120 filed Apr. 14, 2005; U.S. application Ser. No. ______ (Attorney Docket 16071US03) filed Aug. 18, 2005; U.S. application Ser. No. ______ (Attorney Docket 16583US02) filed Aug. 18, 2005; U.S. application Ser. No. ______ (Attorney Docket 16584US02) filed Aug. 18, 2005; U.S. application Ser. No. ______ (Attorney Docket 16585US02) filed Aug. 18, 2005; U.S. application Ser. No. ______ (Attorney Docket 16586US02) filed Aug. 18, 2005; U.S. application Ser. No. ______ (Attorney Docket 16587US02) filed Aug. 18, 2005; U.S. application Ser. No. ______ (Attorney Docket 16588US02) filed Aug. 18, 2005; U.S. application Ser. No. ______ (Attorney Docket 16590US02) filed Aug. 18, 2005; U.S. application Ser. No. ______ (Attorney Docket 16630US02) filed Aug. 18, 2005; and U.S. application Ser. No. ______ (Attorney Docket 16631US02) filed Aug. 18, 2005.

All of the above referenced applications are hereby incorporated herein by reference in their entirety.

### FIELD OF THE INVENTION

Certain embodiments of the invention relate to wireless network communication. More specifically, certain embodiments of the invention relate to a method and system for extensible authentication protocol (EAP) encapsulation exchange for a setup configuration protocol in a WLAN.

### BACKGROUND OF THE INVENTION

Currently, with some conventional systems, setting up a wireless network generally requires significant interaction and technical knowledge on the part of a user setting up the network, especially when the user is configuring security options for the network. For computer savvy users, the tasks associated with setting up a wireless network may be time consuming. However, for inexperienced computer users, the tasks associated with setting up a wireless network may be more challenging and consumes significantly greater time than required by computer savvy users.

In general, 802.11-based networks require a significant amount of user interaction during the configuration process. Typically, with conventional 802.11-based networks, the user needs to configure a station (STA) to associate to an access point (AP), which may require a number of settings to be selected on the STA, and some knowledge of the default configuration of the AP. The user may then access an HTML-based menu on the new AP in order to set various configuration parameters, many of which are difficult for novice and for intermediate users to understand and set correctly. New APs generally start with a configuration that provides no network security, and which utilize a default network name (SSID) that is selected by the manufacturer such as, for example, “Manufacturer Name”, “Default”, or “wireless”. With the proliferation of 802.11 networks, users often experience confusion and network problems when their new AP uses the same SSID as a neighboring AP. In order to facilitate communication between access points and access devices such as wireless STAs, various protocols are required. While 802.11 WLAN standard provides a basis for implementing WLAN, it lacks various features that may be utilized to address the confusion, network problems and issues that users face when, for example, their new AP uses the same SSID as a neighboring AP.

When an access point or configurator configures a new client, it has to change its service set identifier (SSID) to a different value than the one associated with the extended service set (ESS) for nonsecured communication with the client being configured. An ESS may comprise a plurality of basic service sets (BSS)s and may be identified by a unique service set identifier (SSID). The other configured clients in the ESS may lose their connection to the access point and may not be able to access the ESS. After the access point completes the configuration of the new client, the previously configured clients may regain access to the ESS.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for extensible authentication protocol (EAP) encapsulation exchange for a setup configuration protocol in a WLAN, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless network, which may be utilized in connection with an embodiment of the invention.

FIG. 2 is a block diagram of an exemplary system for wireless data communications comprising an ESS with collocation of configurators and access points (AP), in accordance with an embodiment of the invention.

FIG. 3 is a diagram illustrating exemplary message exchanges based on a configuration protocol and initiated at the configurator, in accordance with an embodiment of the invention.

FIG. 4a is a diagram illustrating exemplary exchange of messages with EAP encapsulation based on a configuration setup protocol, which is initiated at an access point, in accordance with an embodiment of the invention.

FIG. 4b is a diagram illustrating exemplary exchange of messages with EAP encapsulation based on a configuration setup protocol, which is initiated at a configurator, in accordance with an embodiment of the invention.

FIG. 5a is a diagram illustrating an exemplary configuration protocol packet type key format, in accordance with an embodiment of the invention.

FIG. 5b is a diagram illustrating an exemplary configuration protocol packet type info format, in accordance with an embodiment of the invention.

### DETAILED DESCRIPTION OF THE INVENTION

Certain aspects of a method for enabling exchange of information in a secure communication network may comprise encapsulating authentication enablement information comprising data for configuring at least one 802.11 client station. One or more 802.11 client stations may be configured without disrupting access to any other 802.11 client station that is already communicatively coupled to the network. The encapsulated authentication enablement information may be authenticated using an extensible authentication protocol (EAP). The setup configuration protocol information may be encapsulated in extensible access protocol (EAP) packets. The access point is configured so that it does not change a SSID to configure new clients. Accordingly, this enables previously configured clients to continue to access an extended service set (ESS) while a new client is being configured.

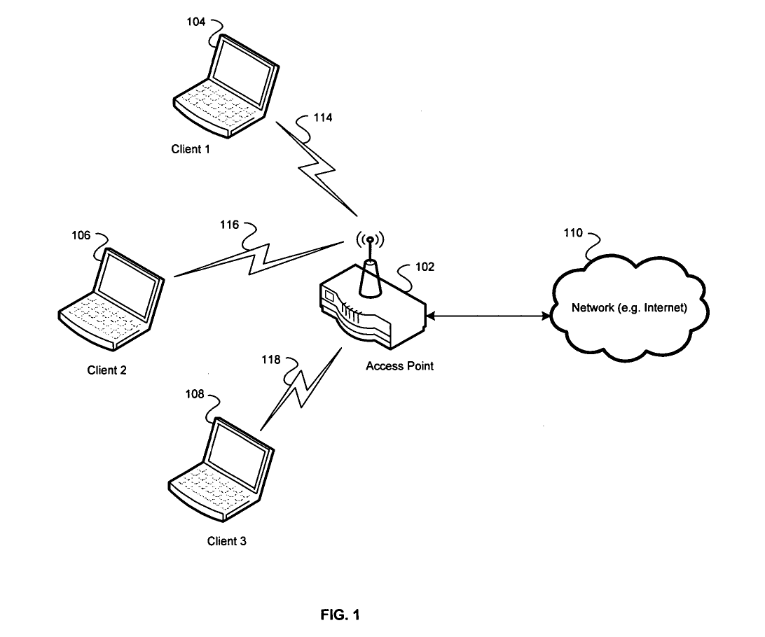

FIG. 1 is a block diagram of an exemplary wireless network, which may be utilized in connection with an embodiment of the invention. Referring to FIG. 1, there is shown an access point (AP) 102, and a plurality of client stations (STA) 104, 106, and 108, a plurality of RF channels 114, 116, and 118, and a network 110. The AP 102 may be utilized as a configurator. The STAs 104, 106, and 108 may be wireless terminals such as a PC, a laptop, or a PDA with integrated or plug-in 801.11 capabilities. For example, the PC may utilize a wireless NIC card and the laptop or PDA may comprise integrated 801.11 capabilities. The network 110 may be a private or public network, for example, a service provider or the Internet.

In operation, in instances where the STAs 104, 106, and 108 are configured, they may communicate with the AP 102 via corresponding secure RF channels 114, 116, and 118, respectively. The AP 102 may communicate information received from a configured STA 104, 106, or 108 via the Internet 110. In instances where the STAs 104, 106, or 108 are unconfigured, they may communicate with the AP 102 functioning as a configurator to request configuration information. The AP 102 functioning as a configurator may configure a requesting STA 104, 106, or 108 via a corresponding RF channel 114, 116, or 118.

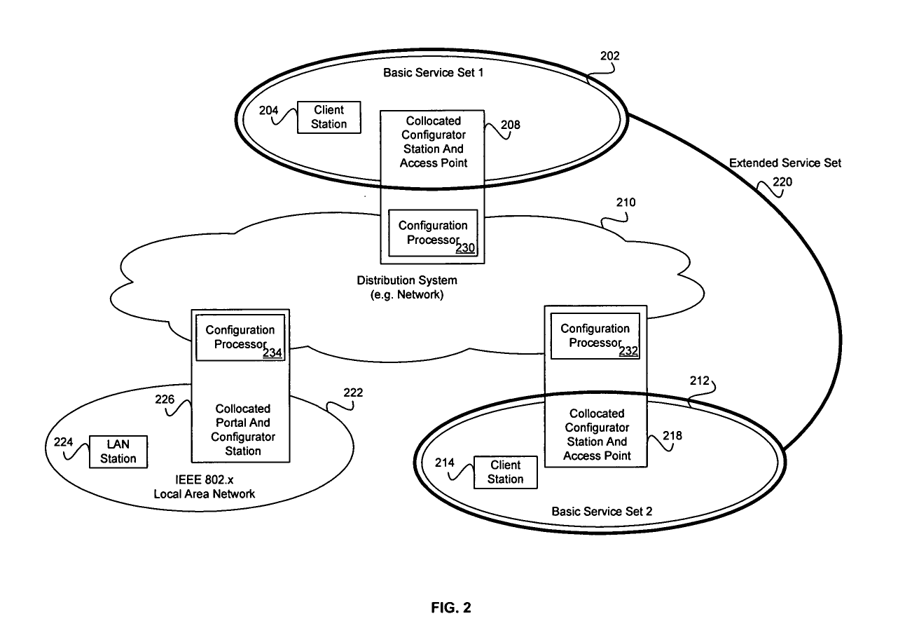

FIG. 2 is a block diagram of an exemplary system for wireless data communications comprising an extended service set (ESS) with collocation of configurators and access points (AP), in accordance with an embodiment of the invention. With reference to FIG. 2 there is shown a distribution system (DS) 210, an extended service set (ESS) 220, and an IEEE 802 LAN 222. The ESS 220 may comprise a first basic service set (BSS) 202, and may include a second BSS 212, and may also include additional BSSs. The first BSS 202 may comprise a client station 204, and a collocated configurator station and access point 208. The collocated configurator station and access point 218 may comprise a configuration processor 230. The second BSS 212 may comprise a client station 214, and a collocated configurator station and access point 218. The collocated configurator station and access point 218 may comprise a configuration processor 232. The IEEE 802 LAN 222 may comprise a LAN station 224, and a collocated configurator station and access point 226. The collocated configurator station and access point 226 may comprise a configuration processor 234.

The collocated configurator station and access point 208 may be adapted to function as an access point or as a configurator station. Throughout this application, for simplicity, collocated configurator station and access point 208 may be referred to as collocated device 208. Accordingly, the collocated device 208 functioning as an access point refers to the collocated configurator station and access point 208 functioning as an access point. Additionally, the collocated device 208 functioning as a configurator refers to the collocated configurator station and access point 208 functioning as a configurator. The plurality of configuration processors, for example, configuration processor 230, 232 and 234 may comprise suitable logic, circuitry and/or code that may be adapted to use authentication enablement information comprising data that specifies a time period during which configuration of at least one 802.11 client station, for example, client station 104 may be allowed.

A BSS 202 may comprise a plurality of proximately located stations that may communicate wirelessly, via a wireless medium. A BSS 202 that is also associated with an ESS 220 may be referred to as an infrastructure BSS. The wireless medium may comprise an RF channel. The ESS 220, comprising a plurality of BSSs, BSS 202 and BSS 212, for example, may be identified by a unique service set identifier (SSID). The portal 226 may also be a member in the ESS 220. Stations 204 and 214, associated with an ESS 220, may communicate via a wireless medium and/or via a distribution system medium, for example the DS 210. The DS 210 may comprise a distribution system medium that further comprises a wired medium and/or a wireless medium. A wired medium may comprise a physical communications channel that enables STA 204 to transmit information via a plurality of communications technologies, for example electrical or optical signals. In an IEEE 802.11 WLAN, the collocated configurator station and access point 208 or collocated configurator station and access point 218 may comprise the functionality of an AP and the functionality of a configurator. In an IEEE 802.11 WLAN, an AP may comprise the functionality of a station.

The collocated device 208 functioning as an AP, may enable STA 204 to transmit information via the DS 210. Portal 226 may enable a LAN station 224, which is located in a traditional IEEE 802 LAN, to communicate with an IEEE 802.11 STA 204, via the DS 210. A traditional IEEE 802 LAN may comprise a wired medium. An IEEE 802 LAN 222 may not comprise an IEEE 802.11 WLAN, for example BSS 202. The DS 210 may utilize media access control (MAC) layer IEEE 802 addressing and/or network layer addressing. If the DS 210 utilizes MAC layer IEEE 802 addressing, the collocated device 208 functioning as an AP, collocated configurator station and access point 218 functioning as an AP, and/or the portal 226 may comprise Ethernet switching device functionality. If the DS 210 utilizes network layer addressing, the collocated device 208 functioning as an AP, collocated configurator station and access point 218 functioning as an AP, and/or the portal 226 may comprise router functionality.

The collocated device 208 functioning as a configurator may configure a STA 204, thereby enabling the STA 204 to communicate wirelessly in a secure IEEE 802.11 network that utilizes encryption. The collocated device 208 functioning as a configurator, may configure a STA 204 by communicating information to the STA 204 comprising an SSID and an encryption key. The encryption key may also be referred to as a passphrase. A configured STA 204 may be authorized to utilize an IEEE 802.11 network based on the received configuration information from the collocated device 208 functioning as a configurator. A process by which the STA 204 is authenticated may comprise configuration of the STA 204. Various embodiments of the invention comprise a method and a system for configuring the STA 204 while requiring less manual intervention from a user than is the case with some conventional methods and/or systems for configuring the STA 204.

A non-AP station, for example, the client station 204 within the BSS 202 may subsequently form an association with the collocated device 208 functioning as an AP. The STA 204 may communicate an association request to the collocated device 208 functioning as an AP, based on the SSID that was received by the STA 204 during configuration. The collocated device 208 functioning as an AP, may communicate an association response to the STA 204 to indicate to the STA 204 the result of the association request. By associating with the collocated device 208 functioning as an AP, the station 204 may become a member of BSS 202. Furthermore, by obtaining membership in BSS 202, the STA 204 may become authorized to engage in secure wireless communication with other client stations in the ESS 220. Similarly, non-AP client station 214 within a BSS 212 may form an association with the collocated configurator station and access point 218 functioning as an AP, enabling the STA 214 to become a member of BSS 212.

Subsequent to the formation of an association between the client station 204 and the collocated device 208 functioning as an AP, the collocated device 208 functioning as an AP, may communicate accessibility information about the client station 204 to other APs associated with the ESS 220, such as the collocated configurator station and access point 218 functioning as an AP, and portals such as the portal 226. In turn, the collocated configurator station and access point 218 functioning as an AP, may communicate accessibility information about the client station 204 to stations in BSS 212. The portal 226, such as for example an Ethernet switch or other device in a LAN, may communicate reachability information about the client station 204 to stations in LAN 222, such as LAN station 224. The communication of reachability information about the client station 204 may enable stations that are not associated in BSS 202, but are associated in ESS 220, to communicate with the client station 204.

The DS 210 may provide an infrastructure that enables a client station 204 in one BSS 202, which has been authenticated and configured in accordance with various embodiments of the invention, to engage in a secure wireless communication with a client station 214 in another BSS 212. The DS 210 may also enable a client station 204 in one BSS 202 to communicate with a LAN station 224 in a non-802.11 LAN 222, such as a wired LAN. The collocated device 208 functioning as an AP, collocated configurator station and access point 218 functioning as an AP, or portal 226 may provide a facility by which a station in a BSS 202, BSS 212, or LAN 222 may communicate information via the DS 210. The client station 204 in BSS 202 may communicate information to a client station 214 in BSS 212 by transmitting the information to collocated device 208 functioning as an AP. The collocated device 208 functioning as an AP may transmit the information via the DS 210 to the collocated configurator station and access point 218 functioning as an AP, which, in turn, may transmit the information to station 214 in BSS 212. The client station 204 may communicate information to a LAN station 224 in LAN 222 by transmitting the information to collocated device 208 functioning as an AP. The collocated device 208 functioning as an AP may transmit the information via the DS 210 to the portal 226, which, in turn, may transmit the information to the LAN station 224 in LAN 222.

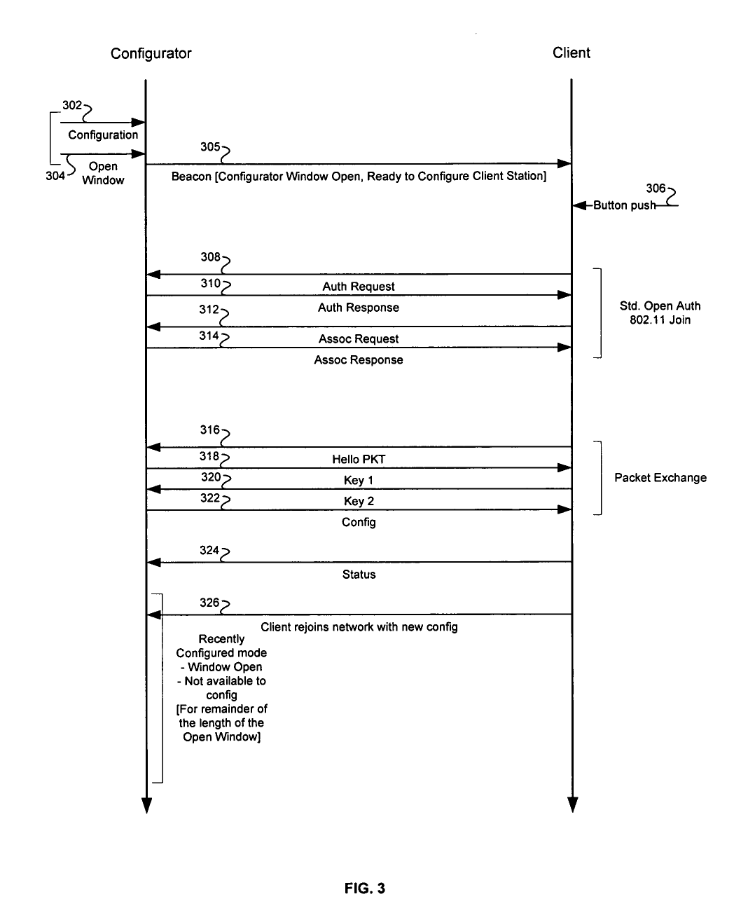

FIG. 3 is a diagram illustrating exemplary message exchanges based on a configuration protocol and initiated at the configurator, in accordance with an embodiment of the invention. FIG. 3 presents an exemplary exchange of messages between the collocated device 208 (FIG. 2) functioning as a configurator, and the client station 204, based on a configuration protocol. In step 302, the collocated device 208 functioning as a configurator, may be configured. A collocated device 208 functioning as a configurator, which is not configured to supply configuration information to a requesting client station 204 during authentication may be referred to as an unconfigured collocated device 208 functioning as a configurator. In an unconfigured collocated device 208 functioning as a configurator, activation of a button located thereon for a specified time duration may initiate step 302.

The time duration for which the button is activated may correspond to, for example, a “short” button activation. In instances where the collocated device 208 functions as a configurator, configuration may comprise entering an SSID, and/or entering a passphrase. The SSID and/or passphrase that is entered and/or generated during the configuration may subsequently be utilized when configuring client stations 204. If a passphrase is not entered, the configurator may be adapted to generate one, which may subsequently be utilized to configure client stations 204. The entered and/or generated configuration information may be stored in non-volatile memory, and/or in a storage device at the collocated device 208, for example. When the collocated device 208 functions as a configurator, it may retrieve the configuration information from the non-volatile memory and/or storage device and use it to configure client stations 204.

In a configured collocated device 208, functioning as a configurator, activation of the button thereon for a specific time duration may result in step 302 being bypassed, and step 304 initiated. The specific time duration for which the button is activated may correspond to, for example, a short button activation. In step 304, a configurator timing window may be opened at the collocated device 208 functioning as a configurator. The opening of the configurator timing window may correspond to the start of a time duration during which a client station 204 may be configured by the collocated device 208 functioning as a configurator. The time during which the configurator timing window remains open subsequent to a short button activation may be configured at the collocated device 208 functioning as a configurator.

In step 305, at a time instant subsequent to the opening of the configurator timing window in step 304, the collocated device 208 functioning as an AP, may transmit IEEE 802.11 beacon frames comprising authentication enablement information, in accordance with an embodiment of the invention. The authentication enablement information may comprise data that indicates when the configurator timing window is open, and that the collocated device 208 functioning as a configurator is ready to configure a client station 204. In one embodiment of the invention, the authentication enablement information may comprise a flag field, window_open, which may be set to a Boolean value to indicate whether the configurator timing window is open or closed. A logical value window_open=TRUE, or a numerical value window_open=1 may indicate that the configurator timing window is open, for example. A logical value window_open=FALSE, or a numerical value window_open=0 may indicate that the configurator timing window is closed, for example. The authentication enablement information may comprise a flag field, recently_cfg, which may be set to a Boolean value to indicate whether the collocated device 208 functioning as a configurator, is ready to configure a client station 204. A logical value recently_cfg=FALSE, or a numerical value recently_cfg=0 may indicate that the collocated device 208 functioning as a configurator, is ready to configure a client station 204, for example. A logical value recently_cfg=TRUE, or a numerical value recently_cfg=1 may indicate that the collocated device 208 functioning as a configurator, has already configured a client station 204 during the current configurator timing window open time interval and is not ready to configure a client station 204, for example.

At a time instant when a configurator timing window is opened, a subsequent first beacon message, associated with the step 305, transmitted by the collocated device 208 functioning as a configurator. The message, associated with the step 305, may comprise flags window_open=TRUE, indicating that the configurator timing window is open, and recently_cfg=FALSE, indicating that the collocated device 208 functioning as a configurator, is ready to configure a client station 204. Beacon frames transmitted by the collocated device 208 functioning as an AP, at instants in time during which the configurator timing window is not open may not comprise authentication enablement information. In step 305, these beacon frames may be received by a client station 204.

In a client station 204, activation of the button, located at a client station 204 may initiate step 306. In step 306, a client timing window may be opened at the client station 204. The opening of the client timing window may correspond to the start of a time duration in which a client station 204 may request to be configured by the collocated device 208 functioning as a configurator. The client station 204 may also start a discovery protocol. The discovery protocol comprises a process by which a client station 204 may locate a collocated device 208 functioning as a configurator, with which to initiate an authentication exchange. The client station 204 may scan beacon frames received from one or more collocated devices 208 functioning as either a configurator or an access point. A beacon frame collocated device 208 functioning as a configurator may comprise authentication enablement information. Subsequent to the opening of the client timing window, the client station 204 may communicate authentication response information to the collocated device 208 functioning as a configurator, via one or more messages associated with the steps 308, 312, 316, 320 and 324. The client station 204 may communicate the one or more messages, associated with the steps 308, 312, 316, 320 and 324, comprising authentication response information based on authentication enablement information contained in the transmitted beacon frame during a time interval in which the configurator timing window was open.

A button located at either the collocated device 208 functioning as a configurator, or the client station 204, may comprise a hardware button, for example a physical button, and/or a software enabled button, for example, a glyph or icon that is displayed in a user interface.

Steps 308, 310, 312, and 314 may comprise message exchanges based on IEEE 802.11 comprising an open authentication and join of a basic service set (BSS) as defined in IEEE 802.11. The BSS utilized during open authentication may utilize a different SSID than that utilized by the infrastructure BSS 202. In step 308, an authentication request message may be sent by the client station 204, to the collocated device 208 functioning as a configurator. In step 310, the collocated device 208 functioning as a configurator, may send an authentication response message to the client station 204. In step 312, the client station 204 may send an association request message, associated with the step 312, to the collocated device 208 functioning as a configurator. In step 314, the collocated device 208 functioning as a configurator, may send an association response message, associated with the step 314, to the client station 204.

Steps 316, 318, 320, and 322 may comprise a packet exchange based on a configuration protocol, in accordance with various embodiments of the invention. The packet exchange may utilize, but may not be limited to, the Diffie-Hellman (DH) protocol. In step 316, the client station 204 may communicate a hello packet to the collocated device 208 functioning as a configurator. The hello packet, associated with the step 316, may indicate to the collocated device 208 functioning as a configurator, that the client station 204 is ready to be configured. In step 318, the collocated device 208 functioning as a configurator, may communicate a key1 message to the client station 204. The key1 message, associated with the step 318, may comprise a configurator key. In step 320, the client station 204 may communicate a key2 message to the collocated device 208 functioning as a configurator. The key2 message, associated with the step 320, may comprise a client key.

In step 322, the collocated device 208 functioning as a configurator, may communicate a configuration message to the client station 204. The configuration message, associated with the step 322, may comprise configuration information that may be utilized to authenticate a client station 204. The configuration information communicated in the configuration message, associated with the step 322, may be encrypted based on the configurator key and/or the client key. In step 324, the client station 204 may communicate a status message to the collocated device 208 functioning as a configurator. The status message 324 may be sent subsequent to decryption of at least a portion of the configuration message 322. The client station 204 may utilize the configurator key and/or the client key to decrypt at least a portion of the configuration message, associated with the step 322 that was previously encrypted by the collocated device 208 functioning as a configurator. The status message, associated with the step 324, may indicate whether the client station 204 was successfully configured during the packet exchange. If the client station was successfully configured, the status message, associated with the step 324, may indicate success. The collocated device 208 functioning as a configurator, may store authentication information about the configured client 204 in persistent memory. Persistent memory may comprise any of a plurality of device storage technologies that may be utilized to maintain information about the configured client station 204 until action is taken to release the stored information from persistent memory. These actions may comprise manual intervention at the collocated device 208 functioning as a configurator, by a user, or automatic intervention by a software process executing at the configurator.

In step 326, the client station 204 may rejoin the WLAN based on the received configuration information. The steps performed during the rejoin, associated with the step 326, may be substantially as defined in IEEE 802.11. The rejoin, associated with the step 326, may occur via a secure RF channel that utilizes the received configuration information in step 322. For example, the rejoin, associated with the step 326, may utilize the SSID that was received by the client station during the packet exchange. Subsequent to configuration of the client station 204, the collocated device 208 functioning as a configurator, may not be available to configure another client station 106 during the current configurator registration window time interval. Beacon frames may be transmitted by the collocated device 208 functioning as an AP, subsequent to the configuration of the client station 204. These beacon frames may comprise information that indicates that the configurator timing window is closed, and that the collocated device 208 functioning as a configurator, has already configured a client station 204 during the current configurator timing window open time duration. This may indicate to a subsequent client station 204 that receives the beacon frames that the collocated device 208 functioning as a configurator, is not currently ready to configure a client station 204.

In various embodiments of the invention, the packet exchange, comprising the steps 316, 318, 320, 322 and 324, may be performed by a collocated device 208 functioning as a configurator, and a client station 204 that communicate wirelessly, via a wireless medium. The collocated device 208 functioning as a configurator, and client station 204 may also communicate during the packet exchange via a wired medium, for example, via an Ethernet LAN 222. If the collocated device 208 functioning as a configurator, receives a packet, for example an authentication request, associated with the step 308, from the client station 204, via a wireless medium, subsequent packet exchanges between the collocated device 208 functioning as a configurator, and client station 204 may be communicated wirelessly. If the collocated device 208 functioning as a configurator receives a packet from the client station 204, via a wired medium, subsequent packet exchanges between the collocated device 208 functioning as a configurator, and client station 204 may be communicated via a wired medium. The received packet may be, for example, a hello packet, associated with the step 316.

In operation, if the time duration for button activation at the collocated device 208 functioning as a configurator, corresponds to a “long” button activation, the collocated device 208 functioning as a configurator, may generate a new SSID and/or passphrase. The new SSID and/or passphrase may replace an SSID and/or passphrase that was stored in the collocated device 208 functioning as a configurator, as configuration information prior to the long button activation. For either a configured, or unconfigured collocated device 208 functioning as a configurator, a long button activation may initiate step 302. Subsequent to a long button activation, the configurator may also release, from persistent memory, configuration information pertaining to previously configured client stations 204. As a consequence, previously configured client stations 204 may lose the ability to engage in secure wireless communications via the BSS 202 or ESS 220. The client stations 204 may be required to repeat the process of authentication with a collocated device 208 functioning as a configurator, to regain the ability to engage in secure wireless communications via the BSS 202 or ESS 220.

The exchange of authentication enablement information, authentication response information and configuration information in messages associated with the steps 305, 308, 310, 312, 314, 316, 318, 320, 322 and 324, between a collocated device 208 functioning as a configurator, and a client station 204, may occur within a time duration in which the configurator timing window is open. The configurator timing window is closed after a time interval corresponding to a configurator timing window open duration lapses or ends. The exchange of authentication enablement information, authentication response information and configuration information, in messages associated with the steps 305, 308, 310, 312, 314, 316, 318, 320, 322 and 324, between a collocated device 208 functioning as a configurator, and a client station 204, may occur within a time duration in which the client timing window is open. After a time interval corresponding to a client timing window open duration lapses, the client timing window is closed.

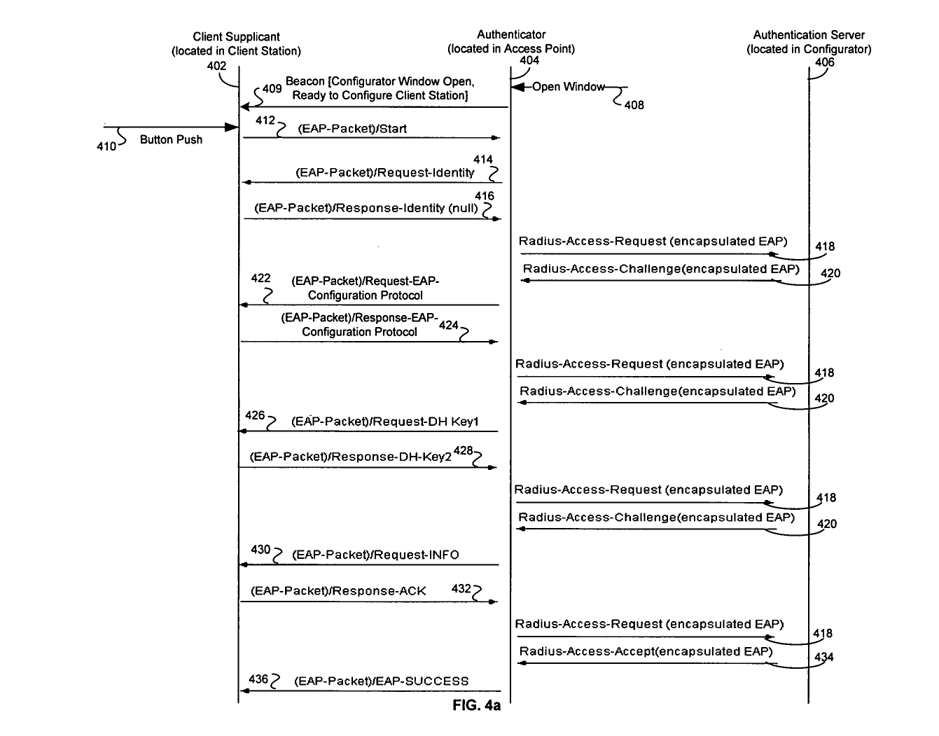

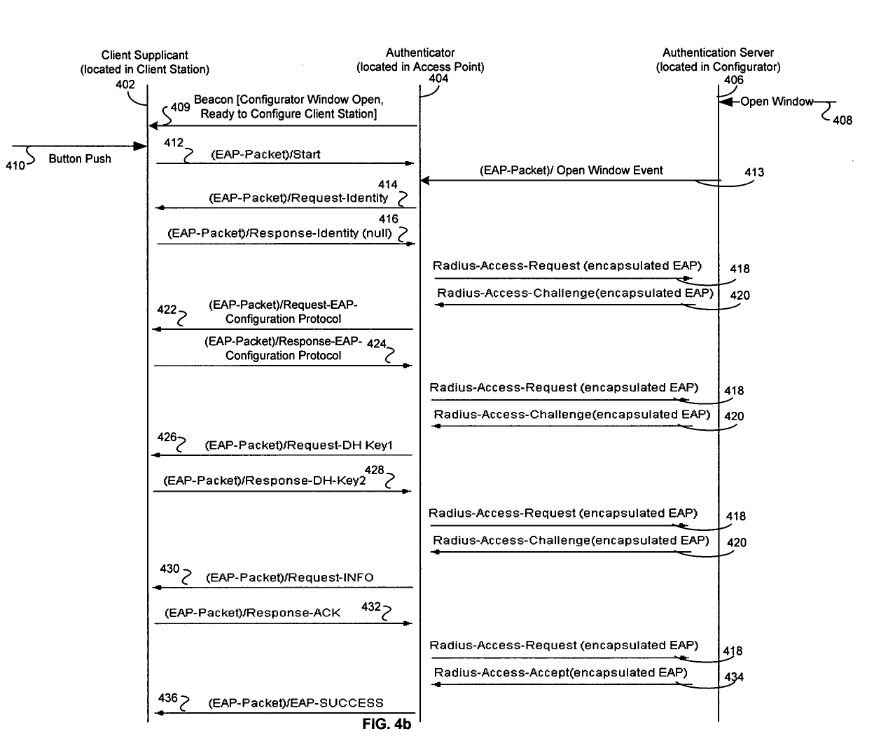

FIG. 4a is a diagram illustrating exemplary exchange of messages with EAP encapsulation based on a configuration setup protocol, which is initiated at an access point, in accordance with an embodiment of the invention. Referring to FIG. 4a, there is shown an exemplary exchange of messages between the client supplicant 402 located in client station 104, the authenticator 404 located in the AP 102 and the authentication server 406 located in the configurator 208, based on the configuration setup protocol. Referring to FIG. 4a, the configurator 208 may function in the role of an authentication server 406 and the AP 102 may function in the role of an authenticator 404. The client station 104 may function in the role of a client supplicant 402 and the client supplicant 404 may initiate a request to be authenticated by an authenticator 404.

The authenticator 404 may facilitate authentication of a client supplicant 402. The authentication server 406 may provide an authentication service to one or more authenticators such as the authenticator 404. The authentication service may be utilized to determine, based on information provided by the client supplicant 402, whether the client supplicant 402 is authorized to communicate information via a communications system to which the authenticator 404 is communicatively coupled. The information provided by the client supplicant 402 may comprise authentication response information.

In step 408, a configuration timing window may be opened at the AP 102. The opening of the configurator timing window may correspond to the start of a time duration during which a client station 104 may be configured by the configurator 208. The configurator timing window may define a period of time during which a client station 104 may be configured by utilizing an AP 102 that may function as an authenticator 404. In various embodiments of the invention, the configurator timing window may be opened based on activation of a button located at the AP 102. The time duration for which the configurator timing window remains open subsequent to a button activation may be configured at the AP 102.

Upon opening of the configurator timing window, the AP 102 may transmit beacon frames 409, in accordance with IEEE 802.11, for example, which comprise authentication enablement information, in accordance with an embodiment of the invention. The beacon frames 409 comprising authentication enablement information may comprise specification of a configurator timing window. This specification may comprise information that indicates whether the configurator 208 is ready to configure a client station 104 that requests configuration, and/or whether the configurator 208 has already configured a client during the current configurator timing window open time interval. Subsequent to the ending of the configurator timing window open time interval, the AP 102 may transmit beacon frames that do not comprise authentication enablement information.

In step 408, a button may be activated at the client station 104. Subsequent to activating a button at a client station 104, the client station 104 may initiate a discovery protocol. The discovery protocol may comprise a process by which a client station 104 locates an AP 102 that may function as an authenticator 404. The client station 104 may initiate a scanning process comprising receipt of one or more beacon frames 409 transmitted by one or more APs 102. A client station 104 may discover an AP 102 that may function as an authenticator 404 when the client station 104 receives a beacon frame 409 that comprises authentication enablement information. An AP 102 that functions as an authenticator may be referred to as an authenticator 404. A configurator 208 that functions in the role of an authentication server to an authenticator 404 may be referred to as an authentication server 406. A client station 104 that functions in the role of supplicant may be referred to as a client supplicant 402. Subsequent to discovery of an AP 102 that may function as an authenticator 404, the client station 104 may perform an open authentication and join with the AP 102 in accordance with IEEE 802.11 procedures.

In step 412, the client supplicant 404 may initiate the discovery protocol by communicating a start EAP packet. In step 414, the authenticator 404 may communicate a request-identity EAP packet to the client supplicant 402 to identify the client station trying to access the AP 102. In step 416, the client supplicant 102 may respond by communicating a response-identity EAP packet to the authenticator 404 confirming its identity.

The remote authentication dial-in user service (RADIUS) authentication process may begin when a remote access user, for example, client supplicant 402 presents authentication information to the authenticator 404. In step 418, after the authenticator 404 has obtained such information, it may authenticate this information using RADIUS. For example, when the client supplicant 402 sends its credentials using the extensible authentication protocol (EAP), the authenticator 404 may create a RADIUS access-request packet encapsulated in EAP containing attributes of the client supplicant 402 requesting access to the network. The attributes of the client supplicant 402 may comprise an ID, a length and an organizational unique identifier (OUI), for example. The attributes of the client supplicant 402 may be adapted to provide authorization enablement information that may be utilized by the authenticator 404 to configure the client supplicant 402 utilizing a configuration protocol.

In step 420, the authentication server 406 may respond by communicating a RADIUS access-challenge packet to the authenticator 404. In step 422, the authenticator 404 may request the type of authentication mechanism that it may use. In step 424, the client supplicant 402 may respond by communicating its support for the requested authentication type.

The RADIUS access-request packet encapsulated in EAP may be sent to the authentication server 406. If no response is returned within a length of time, the request may be re-sent a number of times. The authenticator 404 may also forward requests to an alternate server or servers in the event that the primary server is down or unreachable. An alternate server may be used either after a number of tries to the primary server fail, or in a round-robin fashion, for example. In the case of routing and remote access service, multiple authentication servers 406 may be added and prioritized as authentication providers.

After the authentication server 406 receives the RADIUS access-request packet encapsulated in EAP, it may validate the sending authenticator 404. Validation may occur by verifying that the RADIUS access-request packet encapsulated in EAP is sent from a configured authenticator 404. If the RADIUS access-request packet encapsulated in EAP was sent by a valid authenticator 404, and if digital signatures are enabled for the authenticator 404, the digital signature in the packet may be checked using a shared secret.

In step 426, the authenticator 404 may communicate an encrypted request-key1 EAP packet utilizing an encryption algorithm, for example, the Diffie-Hellman algorithm. The request-key1 EAP packet may specify a value in a session ID that matches the value that may have been contained in a session ID field of a preceding response-configuration protocol EAP packet. An encryption protocol field may specify an encryption type to be utilized during setup configuration and authorization of the client, such as, for example, the Diffie-Hellman algorithm.

In step 428, the client supplicant 402 may respond by communicating a response-key2 EAP packet verifying its identity to the authenticator 404. The response-key2 EAP packet may specify a value in a session ID field that matches the value that may have been contained in the session ID field of a preceding response-configuration protocol EAP packet. A public key field may comprise a public key that was generated utilizing the selected encryption type specified in the encryption protocol field of a preceding request-key1 EAP packet that was received from the authenticator 404. The request-key1 EAP packet and response-key2 EAP packet may be encapsulated EAP packets of key1 and key2 in steps 318 and 320 (FIG. 3) respectively. The authentication server 406 may validate the encrypted key after a request-challenge exchange between the authenticator 404 and the authentication server 406.

In step 430, the authenticator 404 may communicate a request-info EAP packet to the client supplicant 402 to request information regarding the client supplicant 402. In step 432, the client supplicant 402 may respond by communicating a response-ack EAP packet to the authenticator 404. The response-ack EAP packet may comprise a message type field, a session ID field, an encrypted passphrase field, and an SSID field. The session ID field may comprise information that identifies exchanges between a client, such as, for example, client station 104, and a configurator, such as, for example, configurator 208, within an instantiation of a configuration protocol. An encrypted passphrase field and a SSID field may comprise information that is utilized to configure the client based on a configuration protocol.

A SSID/passphrase message may specify a value in the session ID field that matches the value that was contained in the session ID field of a preceding response-configuration protocol EAP packet. The encrypted passphrase field may specify, as ciphertext, a secret key that may be utilized by the client to establish secure communications in an IEEE 802.11 WLAN. The encrypted passphrase field may be decrypted based on the exchange of shared keys in the request-key1 EAP packet and response-key2 EAP packet. The SSID field may specify an ESS, such as, for example, ESS 220, to which the client may become a member.

A request from an authenticator 404 for which the authentication server 406 does not have a shared secret may be discarded. If the authenticator 404 is valid, the authentication server 406 may consult a database of clients to find the client that matches the request. The client's account may contain a list of requirements, at least a portion of which may have to be satisfied in order to allow access for the client supplicant 402. If any condition where the authentication or authorization is not met, the authentication server 406 may send a RADIUS access-reject packet encapsulated in EAP in response, indicating that this user request is invalid.

If the conditions are met, a list of configuration values for the client supplicant 402 may be placed into the RADIUS access-accept packet 434 encapsulated in EAP that may be sent back to the authenticator 404. These values may include a list of RADIUS attributes and other values to deliver the desired service. In step 436, the authenticator 404 may communicate a success EAP packet to the client supplicant 402 allowing access to the client supplicant 402.

In operation, the client station 104 may wirelessly communicate a message, for example an EAP packet that is associated with step 412, to the AP 102. The client station 104 and the AP 102 may be located in a common infrastructure BSS 202. Upon receipt of the message, for example an EAP packet, the AP 102 may recognize the packet based on an Ether type that is associated with the received message. Based on recognition of the Ether type associated with the received message, the AP 102 may communicate the received message to the configurator 208. The configurator 208 may be located in the common infrastructure BSS 202 with the client station 104 and the AP 102. The AP 102 may not be required to change a SSID to configure new clients enabling previously configured clients to continue to access the ESS 220 while a new client, for example, client station 104 is being configured. Accordingly, other stations that are currently using this SSID may continue to do so without loss of connection during configuration of new clients.

The client station 104 may communicate a message, for example an EAP packet such as is associated with step 412, to the configurator 208 via a wired interface, for example via a wired Ethernet medium. The AP 102 may communicate a message, received from the client station 104, to the configurator 208 via a wired interface.

Subsequent to communicating a message, for example an EAP packet associated with step 436, the AP 102 may transmit beacon frames comprising updated authentication enablement information. The updated authentication enablement information may comprise information that indicates if the AP 102 is available to function as an authenticator 404 for client station 104 requesting to be configured by the configurator 208. The updated authentication enablement information may comprise information that indicates whether a client station has already been configured by the configurator 208 during the current configurator timing window open time interval. The updated authentication enablement information may comprise information that indicates whether the configurator 208 is available to configure a requesting client station 104.

FIG. 4b is a diagram illustrating exemplary exchange of messages with EAP encapsulation based on a configuration setup protocol, which is initiated at a configurator, in accordance with an embodiment of the invention. Referring to FIG. 4b, there is shown an exemplary exchange of messages between the client supplicant 402 located in client station 104, the authenticator 404 located in the AP 102 and the authentication server 406 located in the configurator 208 based on the configuration setup protocol. FIG. 4b is substantially as described in FIG. 4a. In FIG. 4a, a configurator timing window is opened at the AP 102. By comparison, in FIG. 4b, a configurator timing window is opened at the configurator 208.

In step 408, a configuration timing window may be opened at the configurator 208. The opening of the configurator timing window may correspond to the start of a time duration during which a client station 104 may be configured by the configurator 208. The configurator timing window may define a period of time during which a client station 104 may be configured by the configurator 208 functioning as an authentication server 406. In various embodiments of the invention, the configurator timing window may be opened based on activation of a button located at the configurator 208. The time duration for which the configurator timing window remains open subsequent to a button activation may be configured at the configurator 208. Upon opening of the configurator timing window, in step 413, the configurator 208 may communicate an open window event message to the AP 102, for example. The open window event message, for example, may comprise a notification from the configurator 208 to the AP 102 that a configurator timing window has been opened. The configurator 208 may selectively communicate the open window notification to one or more APs 102. An AP 102 that receives the open window notification from the configurator 208 may subsequently transmit beacon frames 409 that comprise authentication enablement information.

Subsequent to closing of the configurator timing window, when the window open time interval ends, the configurator 208 may communicate a close window event message to the AP 206, for example. The close window event message, for example, may comprise a closed window notification from the configurator 208 to the AP 102 that a configurator timing window has expired. The configurator 208 may selectively communicate the closed window notification to one or more APs 102. An AP 102 that receives the closed window notification from the configurator 208 may subsequently transmit beacon frames that do not comprise authentication enablement information.

In step 410, a button may be activated at the client station 104. Subsequent to activating a button at a client station 104, the client station 104 may initiate a discovery protocol. The client station 104 may initiate a scanning process comprising receipt of one or more beacon frames transmitted by one or more APs 102. A client station 104 may discover an AP 102 that may function as an authenticator 404 when the client station 104 receives a beacon frame 409 that comprises authentication enablement information. Subsequent to discovery of an AP 102 that may function as an authenticator 404, the client station 104 may perform an open authentication and join with the AP 102 in accordance with IEEE 802.11 procedures.

An AP 102 that functions as an authenticator 404 may be configured to locate a configurator 208 that functions as an authentication server 406. The configurator configuration information at the AP 102 may comprise: an SSID, a passphrase, a configurator address, a proxy enable flag, and/or an open window button location parameter. The configurator address may comprise an address, associated with a network, that may be affixed to a message, for example an EAP packet that is associated with step 418, such that a message so affixed may be delivered to a configurator 208, via the network. The configurator address may be affixed to the message by the AP 102, for example. The network may comprise a DS 210, a BSS 202, and/or a LAN 222. The proxy enable flag may comprise a variable that may be set to a value, for example a Boolean value of TRUE or FALSE. A value proxy enable flag=TRUE may enable the AP 102 to recognize an Ether type associated with a received packet, for example a packet received from a client station 104 associated with an EAP Ether type, and transmit the received packet to the configurator 208, located at the configurator address, via a DS 210.

The open window button location parameter may indicate, to the AP 102, a location of a button that may be activated to initiate a configurator timing window open time interval. The open window button location parameter may indicate that the button to be activated is located at the AP 102, or at the configurator 208 for example. If the button to be activated is located at the AP 102, then the configurator timing window open time interval may be started by activating a button located at the AP 102. The procedures associated with this option are illustrated in FIG. 4a. If the button to be activated is located at the configurator 208, then the configurator timing window open time interval may be started by activating a button located at the configurator 208. The procedures associated with this option are illustrated in FIG. 4b.

An AP 102 may be configured by a configurator 208 via a wired interface. A button, located at a configurator 208, which is activated may result in notification messages being communicated via a wired network, for example a LAN 222. The notification message may utilize a broadcast address such that the notification message is communicated to a plurality of devices that are communicatively coupled to the LAN 222. The notification message may comprise information that indicates that the configurator 208 may function as an AP-configurator. The notification message may comprise an EAP echo message, for example. A button, located at the AP 102, which is activated may result in the AP 102 communicating a notification response message to the configurator 208. The notification response message may comprise information substantially as described for the hello packet associated with step 316 (FIG. 3). The notification response message may comprise an EAP reply message, for example. The AP 102 may subsequently exchange messages comprising configurator configuration information with the configurator 208 substantially as described in FIG. 4a.

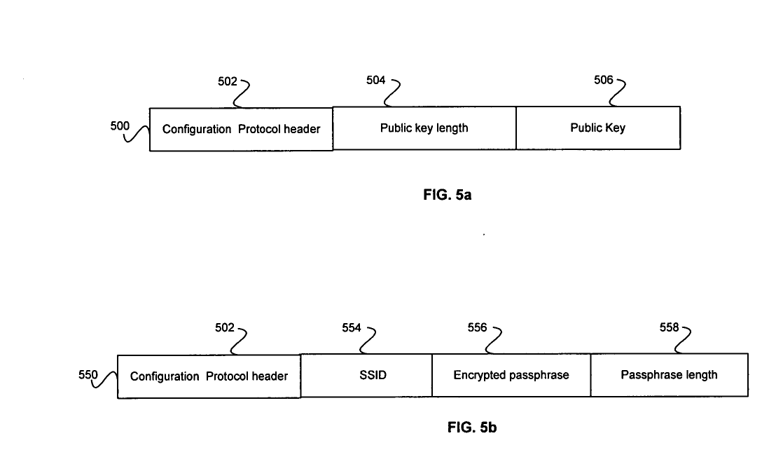

FIG. 5a is a diagram illustrating an exemplary configuration protocol packet type key format, in accordance with an embodiment of the invention. With reference to FIG. 5a, there is shown a configuration protocol packet type key format 500. The configuration protocol packet type key 500 comprises a configuration protocol header 502, a public key length 504 and a public key 506.

The configuration protocol packet type key 1 and the configuration protocol packet type key 2 may have a format similar to the configuration protocol packet type key format 500. The public key length field 504 may comprise information that indicates the length of the public key utilized. The public key field 506 may comprise algorithm information that specifies the public key 1 for the configuration protocol packet type key 1 or public key 2 for the configuration protocol packet type key 2. For example, an encryption type may be specified during setup configuration and authorization of the client such as, for example, the Diffie-Hellman (DH) algorithm. The public key field 506 for the public key 1 message may comprise the configurator's generated public key for algorithm information exchange, for example, DH algorithm information exchange. The public key field 506 for the public key 2 message may comprise the client's generated public key for algorithm information exchange, for example, DH algorithm information exchange. The client, for example, client station 204 may transmit a public key 2 message as illustrated in step 324 in response to a transmitted public key 1 message as illustrated in step 322 previously received from a configurator. The public key 2 message may be transmitted as plaintext.

U.S. application Ser. No. ______ (Attorney Docket No. 16585US02) filed Aug. __, 2005, provides a detailed description of a configuration protocol header, and is hereby incorporated by reference in its entirety.

FIG. 5b is a diagram illustrating an exemplary configuration protocol packet type info format, in accordance with an embodiment of the invention. With reference to FIG. 5b, there is shown configuration protocol packet type info format 550. The configuration protocol packet type info format 550 comprises a configuration protocol header 502, a service set identifier (SSID) field 554, an encrypted passphrase field 556 and a passphrase length field 558.

The SSID field 554 may comprise a unique identifier attached to the header of the configuration protocol packets sent over a WLAN that may act as a password when a client station, for example, client station 204 tries to connect to the BSS, for example, BSS 202. The SSID field 554 may comprise information that indicates the SSID of the secure configuration protocol network. The SSID field 554 may specify an ESS, such as, for example, ESS 220, to which the client may become a member. The encrypted passphrase field 556 may comprise information that is utilized to configure the client based on a configuration protocol. The encrypted passphrase field 556 may be randomly generated at the AP 102 and transmitted to the client 104 in an encrypted format. The key for the encryption may be derived using the Diffie-Hellman (DH) protocol or its variant, for example. The DH protocol may generate a shared 1536-bit key, for example. This key may be converted to a 128-bit key using an encryption algorithm such as secure hass access 1 (SHA1), for example. The 128-bit key may be utilized for advanced encryption standard (AES) wrapping of the encrypted passphrase before being transmitted over the air. The encrypted passphrase field 556 may specify, as ciphertext, a secret key that may be utilized by the client to establish secure communications in an IEEE 802.11 WLAN. The encrypted passphrase field 556 may be decrypted based on the exchange of shared keys in the public key 1 message and the public key 2 message. The passphrase length field 558 may comprise information that indicates the length of the encrypted passphrase.

Certain aspects of a system for enabling exchange of information in a secure communication system may comprise at least one configuration processor, for example, configuration processor 230 that configures at least one new 802.11 client station to access an 802.11 WLAN network without disrupting access to at least one other 802.11 client station already connected to the 802.11 WLAN network. The configuration processor 230 may be adapted to encapsulate authentication enablement information comprising configuration data for configuring at least one new 802.11 client station, for example, client station 204.

The encapsulated authentication enablement information may be authenticated using an extensible authentication protocol (EAP). The authentication enablement information may comprise configuration data that specifies a time period during which configuration of the new 802.11 client station 204 is allowed. The configuration processor 230 may be adapted to receive at least one encapsulated start message as illustrated in step 412 that requests access to the network 110 from the new 802.11 client station 204. The configuration processor 230 may be adapted to communicate at least one encapsulated request identity message as illustrated in step 414 that requests identity information of the new 802.11 client station 204 in response to the received at least one encapsulated start message. The configuration processor 230 may be adapted to receive at least one encapsulated response identity message as illustrated in step 416 comprising attributes of the new 802.11 client station 104 in response to the communicated at least one encapsulated request identity message.

The configuration processor 230 may be adapted to communicate at least one encapsulated access request message as illustrated in step 418 that comprises the attributes of the new 802.11 client station 204 to an authentication server, for example, the authentication server 406 located in configurator 208.

The attributes of the client supplicant 402 may comprise an ID, a length and an organizational unique identifier (OUI), for example. The attributes of the client supplicant 402 may be adapted provide authorization enablement information that may be utilized by the authenticator 404 to configure the client supplicant 402 utilizing a configuration protocol.

The configuration processor 230 may be adapted to receive at least one encapsulated access challenge message as illustrated in step 420 that comprises authentication information from the authentication server 406 in response to the communicated at least one encapsulated access request message. The configuration processor 230 may be adapted to receive at least one encapsulated access accept message as illustrated in step 434 that confirms authentication of the new 802.11 client station 204 from the authentication server 406. The configuration processor 230 may communicate at least one encapsulated success message as illustrated in step 436 allowing access to the new 802.11 client station 204 in response to the received at least one encapsulated access accept message.

Another embodiment of the invention may provide a machine-readable storage, having stored thereon, a computer program having at least one code section executable by a machine, thereby causing the machine to perform the steps as described above for extensible authentication protocol (EAP) encapsulation exchange for a setup configuration protocol in a WLAN.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for enabling exchange of information in a secure communication network, the method comprising configuring at least one new 802.11 client station by a configurator to access an 802.11 WLAN network without disrupting access to at least one other 802.11 client station already connected to the 802.11 WLAN network.

2. The method according to claim 1, further comprising encapsulating authentication enablement information comprising configuration data for configuring said at least one new 802.11 client station

3. The method according to claim 2, further comprising authenticating said encapsulated authentication enablement information using an extensible authentication protocol (EAP).

4. The method according to claim 2, wherein said configuration data specifies a time period during which configuration of said at least one new 802.11 client station is allowed.

5. The method according to claim 1, further comprising receiving at least one encapsulated start message that requests access to said 802.11 WLAN network from said at least one new 802.11 client station.

6. The method according to claim 5, further comprising communicating at least one encapsulated request identity message that requests identity information of said at least one new 802.11 client station in response to said received said at least one encapsulated start message.

7. The method according to claim 6, further comprising receiving at least one encapsulated response identity message comprising attributes of said at least one new 802.11 client station in response to said communicated said at least one encapsulated request identity message.

8. The method according to claim 7, further comprising communicating at least one encapsulated access request message that comprises said attributes of said at least one new 802.11 client station to an authentication server.

9. The method according to claim 8, further comprising receiving at least one encapsulated access challenge message comprising authentication information from said authentication server in response to said communicated said at least one encapsulated access request message.

10. The method according to claim 9, further comprising receiving at least one encapsulated access accept message that confirms authentication of said at least one new 802.11 client station from said authentication server.

11. A system for enabling exchange of information in a secure communication network, the system comprising a configuration processor that configures at least one new 802.11 client station to access an 802.11 WLAN network without disrupting access to at least one other 802.11 client station already connected to the 802.11 WLAN network.

12. The system according to claim 11, wherein said configuration processor encapsulates authentication enablement information comprising configuration data for configuring said at least one new 802.11 client station.

13. The system according to claim 12, wherein said configuration processor authenticates said encapsulated authentication enablement information using an extensible authentication protocol (EAP).

14. The system according to claim 12, wherein said configuration data specifies a time period during which configuration of said at least one new 802.11 client station is allowed.

15. The system according to claim 11, wherein said at least one configuration processor receives at least one encapsulated start message that requests access to said 802.11 WLAN network from said at least one new 802.11 client station.

16. The system according to claim 15, wherein said at least one configuration processor communicates at least one encapsulated request identity message that requests identity information of said at least one new 802.11 client station in response to said received said at least one encapsulated start message.

17. The system according to claim 16, wherein said at least one configuration processor receives at least one encapsulated response identity message comprising attributes of said at least one new 802.11 client station in response to said communicated said at least one encapsulated request identity message.

18. The system according to claim 17, wherein said at least one configuration processor communicates at least one encapsulated access request message that comprises said attributes of said at least one new 802.11 client station to an authentication server.

19. The system according to claim 18, wherein said at least one configuration processor receives at least one encapsulated access challenge message comprising authentication information from said authentication server in response to said communicated said at least one encapsulated access request message.

20. The system according to claim 19, wherein said at least one configuration processor receives at least one encapsulated access accept message that confirms authentication of said at least one new 802.11 client station from said authentication server.

21. A machine-readable storage having stored thereon, a computer program having at least one code section for enabling exchange of information in a secure communication network, the at least one code section being executable by a machine for causing the machine to perform steps comprising configuring at least one new 802.11 client station by a configurator to access an 802.11 WLAN network without disrupting access to at least one other 802.11 client station already connected to the 802.11 WLAN network.

22. The machine-readable storage according to claim 21, further comprising code for encapsulating authentication enablement information comprising configuration data for configuring said at least one new 802.11 client station

23. The machine-readable storage according to claim 22, further comprising code for authenticating said encapsulated authentication enablement information using an extensible authentication protocol (EAP).

24. The machine-readable storage according to claim 22, wherein said configuration data specifies a time period during which configuration of said at least one new 802.11 client station is allowed.

25. The machine-readable storage according to claim 21, further comprising code for receiving at least one encapsulated start message that requests access to said 802.11 WLAN network from said at least one new 802.11 client station.

26. The machine-readable storage according to claim 25, further comprising code for communicating at least one encapsulated request identity message that requests identity information of said at least one new 802.11 client station in response to said received said at least one encapsulated start message.

27. The machine-readable storage according to claim 26, further comprising code for receiving at least one encapsulated response identity message comprising attributes of said at least one new 802.11 client station in response to said communicated said at least one encapsulated request identity message.

28. The machine-readable storage according to claim 27, further comprising code for communicating at least one encapsulated access request message that comprises said attributes of said at least one new 802.11 client station to an authentication server.

29. The machine-readable storage according to claim 28, further comprising code for receiving at least one encapsulated access challenge message comprising authentication information from said authentication server in response to said communicated said at least one encapsulated access request message.

30. The machine-readable storage according to claim 29, further comprising code for receiving at least one encapsulated access accept message that confirms authentication of said at least one new 802.11 client station from said authentication server.
